(19) United States
(12) Patent Application Publication
(10) Pub. No.: US 2020/0259863 A1
(43) Pub. Date: Aug. 13, 2020

(54) SECURITY SOCKET LAYER DECRYPTION METHOD FOR SECURITY

(71) Applicant: SOOSAN INT CO., LTD., Seoul (KR)

(72) Inventors: Yong Hwan Lee, Seoul (KR); Chul Woong Yang, Seoul (KR); Woo Suk Yang, Seoul (KR)

(21) Appl. No.: 16/642,485

(22) PCT Filed: Aug. 29, 2018
(86) PCT No.: PCT/KR2018/009935

§ 371 Date: Feb. 27, 2020

(30) Foreign Application Priority Data
Aug. 29, 2017 (KR) 10-2017-0109665
Mar. 5, 2018 (KR) 10-2018-0026044

(51) Int. Cl. H04L 29/06

(52) U.S. Cl. CPC H04L 63/168; H04L 63/166; H04L 69/163; H04L 63/0272; H04L 63/0428

(57) ABSTRACT

The present invention relates to a security socket layer decryption method, and relates to a technique which: senses a packet, relating to an SSL handshake for establishing an SSL connection between a client and a server, after a transmission control protocol (TCP) session is set up between the client and the server in an SSL decryption device; configures SSL between the client and the SSL decryption device; configures SSL between the SSL decryption device and the server; sets up a TCP session between a virtual client corresponding to the client and a virtual server responding to the server; transmits packets transmitted and received between the virtual client and the virtual server to a security device when setting up the TCP session; and upon receiving a first SSL packet delivered to the SSL decryption device from the client, decrypts and transmits the first SSL packet to the security device, and re-encrypts and transmits the decrypted first SSL packet to the server.

### TECHNICAL FIELD

The following description relates to a method for decrypting and providing a secure sockets layer (SSL) packet to a security device in an SSL decryption device which decrypts and provides encrypted traffic such that the existing security device may examine the encrypted traffic.

### BACKGROUND ART

A large amount of information in organizations such as enterprises is leaked to the outside through the Internet. Furthermore, the organizations are attacked many times from external networks.

To prevent data leakage and respond to attacks from the outside, an enterprise examines packets transmitted from a terminal in the enterprise and packets received from the outside and releases problematic connections.

However, when a website the terminal will access uses secure sockets layer (SSL) communication, because contents of transmitted/received packets are encrypted and transmitted, there is a problem in which it is impossible to verify whether there is data leakage or an attack.

To address it, previously, an enterprise maintains security using a method of blocking communication with an external site using SSL communication.

However, because blocking the external site using the SSL communication is able to reduce work efficiency of employees of the enterprise, there is a need for a method capable of examining packets transmitted using the SSL communication in a security device rather than simply blocking the external site.

### DISCLOSURE OF INVENTION

### Technical Subject

To address at least the above-mentioned problems of the existing technology, an aspect provides a method for decrypting and providing an SSL packet to a security device in an SSL decryption device which decrypts and provides the SSL packet such that the existing security device may examine the SSL packet.

In detail, another aspect also provides a method for setting up a TCP session between a virtual client and a virtual server, transmitting a packet transmitted and received to set up the TPC session between the virtual client and the virtual server to a security device, intercepting and decrypting an SSL packet transmitted and received between a client and a server to be changed to the TCP packet between the virtual client and the virtual server and be transmitted to the security device in an SSL decryption device of the present invention, such that the existing security device may examine encryption communication without separate correction only by examining the transmitted TCP packet.

### Technical Solution

According to an aspect of the present invention, there is provided a secure sockets layer (SSL) decryption method in an SSL decryption device including, after a transmission control protocol (TCP) session between a client and a server is set up, detecting a packet about an SSL handshake for establishing an SSL connection between the client and the server, configuring an SSL between the client and the SSL decryption device and configuring an SSL between the SSL decryption device and the server, setting up a TCP session between a virtual client corresponding to the client and a virtual server corresponding to the server and transmitting a packet transmitted and received between the virtual client and the virtual server when setting up the TCP session to a security device, and, when receiving a first SSL packet transmitted from the client to the SSL decryption device, decrypting and transmitting the first SSL packet to the security device and re-encrypting and transmitting the decrypted first SSL packet to the server.

At this time, the decrypting and transmitting of the first SSL packet to the security device and the re-encrypting and transmitting of the decrypted first SSL packet to the server may include, when receiving the first SSL packet transmitted from the client to the SSL decryption device, decrypting the first SSL packet, generating a first TCP packet including a payload of the decrypted first SSL packet transmitted from the virtual client to the virtual server, transmitting the first TCP packet to the security device, generating a second SSL packet including a payload of the decrypted first SSL packet, and transmitting the second SSL packet to the server.

At this time, the method may further include, when receiving a third SSL packet transmitted from the server to the SSL decryption device, decrypting and transmitting the third SSL packet to the security device and re-encrypting and transmitting the decrypted third SSL packet to the client.

At this time, the decrypting and transmitting of the third SSL packet to the security device and the re-encrypting and transmitting of the decrypted third SSL packet to the client may include, when receiving the third SSL packet transmitted from the server to the SSL decryption device, decrypting the third SSL packet, generating a second TCP packet including a payload of the decrypted third SSL packet transmitted from the virtual server to the virtual client, transmitting the second TCP packet to the security device, generating a fourth SSL packet including a payload of the decrypted third SSL packet, and transmitting the fourth packet to the client.

At this time, the method may further include, when it is detected that the TCP session between the client and the server is ended, ending the TCP session between the virtual client and the virtual server and transmitting a packet transmitted and received between the virtual client and the virtual server when ending the TCP session to the security device.

At this time, the method may further include, when receiving a request to transmit a message to the client from the security device, generating and transmitting a fifth SSL packet including the message to the client.

At this time, the request to transmit the message to the client from the security device may be determined as a request to transmit the message to the client from the security device when receiving a FIN packet including the message transmitted to the client from the security device and when receiving an RST packet transmitted to the server from the security device.

At this time, the method may further include, when receiving a request to disconnect the connection between the client and the server from the security device, disconnecting the connection between the client and the server and ending the TCP session between the virtual client and the virtual server and transmitting a packet transmitted and received between the virtual client and the virtual server when ending the TCP session to the security device.

At this time, the request to disconnect the connection between the client and the server from the security device may be determined as a request to disconnect the connection between the client and the server when receiving an RST packet transmitted to each of the client and the server from the security device.

At this time, the setting up of the TCP session between the virtual client corresponding to the client and the virtual server corresponding to the server and the transmitting of the packet transmitted and received between the virtual client and the virtual server when setting up the TCP session to the security device may include matching and storing five tuples of the virtual client, corresponding to five tuples of the client, and matching and storing five tuples of the virtual server, corresponding to five tuples of the server.

At this time, client IPs, server IPs, and server ports may have the same value as each other and client ports may have different values from each other, when comparing information of the TCP session which is set up between the client and the server with information of the TCP session which is set up between the virtual client and the virtual server.

### Advantageous Effects

The present invention relates to a method for relaying SSL communication between a client and a server and decrypting and transmitting the SSL communication to a security device, which may receive a decrypted SSL packet and may verify a security problem using an existing security device without a specific action.

### BRIEF DESCRIPTION OF DRAWINGS

FIG. 1 is a drawing illustrating a schematic configuration of a security system capable of examining a packet in secure sockets layer communication according to an embodiment of the present invention;

FIG. 2 is a drawing illustrating a process of decrypting and transmitting an SSL packet to a security device in an SSL decryption device of a security system according to an embodiment of the present invention;

FIG. 3 is a drawing illustrating a process of processing a message transmission request or a disconnection request transmitted from a security device of a security system according to an embodiment of the present invention;

FIG. 4 is a flowchart illustrating a process of decrypting and providing an SSL packet to a security device in an SSL decryption device according to an embodiment of the present invention;

FIG. 5 is a flowchart illustrating in detail a process of processing an SSL packet transmitted by a client in an SSL decryption device according to an embodiment of the present invention; and

FIG. 6 is a flowchart illustrating in detail a process of processing an SSL packet transmitted by a server in an SSL decryption device according to an embodiment of the present invention.

### BEST MODE FOR CARRYING OUT THE INVENTION

A specific structural or functional description of embodiments according to the concept of the present invention this specification has been merely illustrated for the purpose of describing the embodiments according to the concept of the present invention, and the embodiments according to the concept of the present invention may be implemented in various forms and are not limited to embodiments described in this specification.

The embodiments according to the concept of the present invention may be changed in various ways and may have various forms, and thus the embodiments are illustrated in the drawings and described in detail in this specification. However, this is not intended to limit the embodiments according to the concept of the present invention to specific disclosed forms and includes all of changes, equivalents or substitutes included in the spirit and technical scope of the present invention.

Terms such as “first” or “second” may be used for describing various components, but the components should not be limited by the terms. The terms may be used only for distinguishing one component from other components, for example, a first component may be referred to as a second component, and similarly, a second component may be referred to as a first component, without departing from the claims according to the concept of the present invention.

It will be understood that when a component is referred to as being “coupled with/to” or “connected to” another component, it can be directly coupled with/to or connected to the other component or an intervening component may be present. In contrast, when a component is referred to as being “directly coupled with/to” or “directly connected to” another component, it should be understood that there are no intervening component. Other expressions describing the relationships among the elements, for example, “between,” “directly between” or “adjacent to” and “directly adjacent to” may also be analyzed similarly.

The terms used in the specifications are used only for describing specific embodiments, is not intended to limit the prevent invention. The expression of singular number includes the expression of plural number unless clearly intending otherwise in a context. In the specification, it should be understood that terms of ‘comprise’, ‘have’, and the like are to designate the existence of a feature disclosed in the specification, a numeral, a step, an input, a constituent element, a part, or a combination thereof, and do not previously exclude a possibility of existence or supplement of one or more other features, numerals, steps, inputs, constituent elements, parts, or combinations thereof

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the inventive concept.

Hereinafter, embodiments will be described with reference to the accompanying drawings. However, the scope of the patent application is restricted or limited by these embodiments. The same reference numerals shown in each drawing represent the same members.

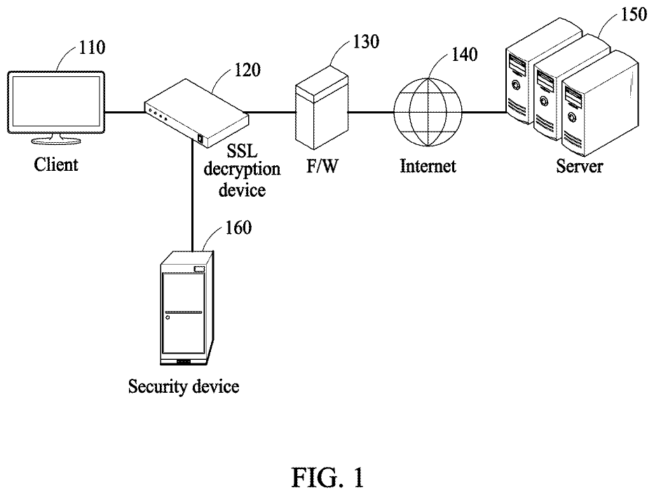

Hereinafter, a description will be given in detail of a secure sockets layer decryption method for security in a security system according to an embodiment of the present invention with reference to FIGS. 1 to 6.

FIG. 1 is a drawing illustrating a schematic configuration of a security system capable of examining a packet in secure sockets layer communication according to an embodiment of the present invention.

Referring to FIG. 1, the security system may include an SSL decryption device and a security device.

At least one or more client (110)s may access a network. For example, the client may be a terminal such as a PC, a smartphone.

The secure sockets layer (SSL) decryption device 120 may relay TCP communication and SSL communication between the client 110 and a server 150. A TCP packet may be mirrored to be transmitted to the security device 160, and an SSL packet may be decrypted to be changed to a TCP packet and be transmitted to the security device 160.

At this time, the SSL decryption device 120 may previously set up a TCP session between a virtual client and a virtual server and may transmit a handshake packet transmitted and received when setting up the virtual TCP session to the security device 160, such that the existing security device 160 may process the decrypted and changed TCP packet in an existing manner.

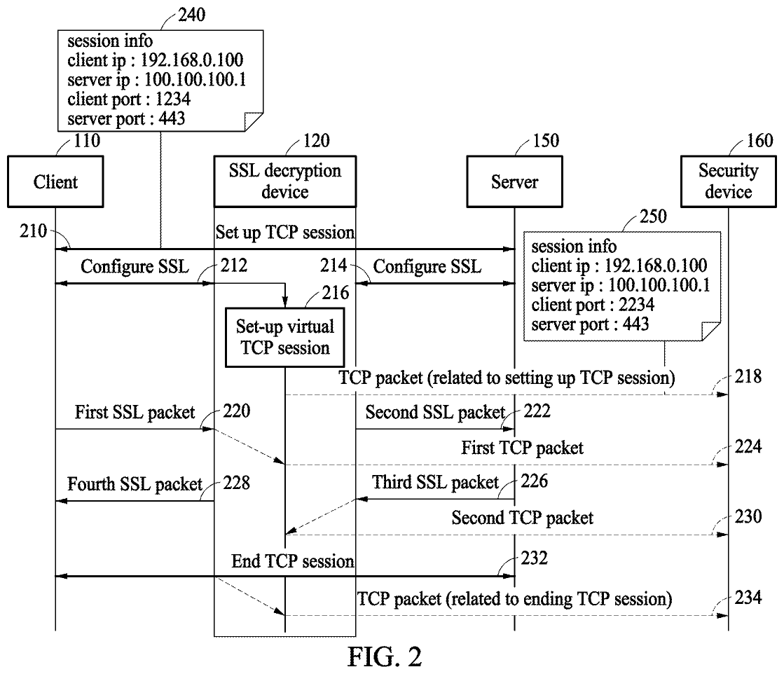

More detailed contents of the SSL decryption device 120 will be described in detail below with reference to FIGS. 2. To 6.

Like the operation of the existing security device 160, the security device 160 may examine data included in the received packet to check whether contents, dissemination of which is prohibited, are included or whether a virus is included, and may transmit a message to the client 110 or may transmit a session control message for ending the TCP session between the client 110 and the server 150.

Meanwhile, when a packet is transmitted to the server 150 through the Internet 140 from the client 110 in a network environment, it may be transmitted through a firewall 130.

Hereinafter, a description will be given of a secure sockets layer decryption method for security in the security system according to the present invention with the above configuration with reference to the following drawings.

FIG. 2 is a drawing illustrating a process of decrypting and transmitting an SSL packet to a security device in an SSL decryption device of a security system according to an embodiment of the present invention.

Referring to FIG. 2, a client 110 may set up a TCP session for communication with a server 150 (210). The setting up of the TCP session may be set up through a 3-way handshake between a client 110 and a server 150.

An SSL decryption device 120 may be located between the client 110 and the server 150 to mirror the transmitted and received packet and detect whether the TPC session is set up.

After the TCP session between the client 110 and the server 150 is set up, when a packet (e.g., an SSL Hello packet) about an SSL handshake for establishing an SSL connection between the client 110 and the server 150 is detected, without transmitting the packet about the SSL handshake to the server 150, the SSL decryption device 120 may configure an SSL between the client 110 and the SSL decryption device 120 (212) and may configure an SSL between the SSL decryption device 120 and the server 150 (214). At this time, the configuring of the SSL may be configured through a 3-way handshake between the client 110 and the SSL decryption device 120 or between the SSL decryption device 120 and the server 150.

Then, the SSL decryption device 120 may set up a virtual TCP session between a virtual client corresponding to the client 110 and a virtual server corresponding to the server 150 (216) and may transmit a packet transmitted and received to set up the TCP session between the virtual client and the virtual server to a security device 160 (218).

At this time, the SSL decryption device 120 may match and store five tuples of the virtual client, corresponding to five tuples of the client 110, and may match and store five tuples of the virtual server, corresponding to five tuples of the server 150, to search for a corresponding device subsequently. The five tuples may include at least one of a source IP, a source port, a destination IP, a destination port, a TCP sequence number, and a TCP/UDP protocol.

Meanwhile, when comparing information 240 of the TCP session which is set up between the client 110 and the server 150 with information 250 of the TCP session which is set up between the virtual client and the virtual server, a client 110 IP, a server 150 IP, and a server 150 port have the same value, and a client 110 port has a different value.

Then, when receiving a first SSL packet transmitted from the client 110 to the SSL decryption device 120 (220), the SSL decryption device 120 may decrypt the first SSL packet, may generate a second SSL packet including a payload of the decrypted first SSL packet, and may transmit the second SSL packet to the server 150 (222).

Then, the SSL decryption device 120 may generate and transmit a first TCP packet including a payload of the decrypted first SSL packet transmitted from the virtual client to the virtual server to the security device 160 (224).

Then, when receiving a third SSL packet transmitted from the server 150 to the SSL decryption device 120 (226), the SSL decryption device 120 may decrypt the third SSL packet, may generate a fourth SSL packet including a payload of the decrypted third SSL packet, and may transmit the fourth SSL packet to the client 110 (228).

Then, the SSL decryption device 120 may generate and transmit a second TCP packet including a payload of the decrypted third SSL packet transmitted from the virtual server to the virtual client to the security device 160 (230).

Thereafter, when it is detected that the TCP session between the client 110 and the server 150 is ended (232), the SSL decryption device 120 may end the TCP session between the virtual client and the virtual server and may transmit a packet transmitted and received when ending the TCP session between the virtual client and the virtual server to the security device 160 (234). At this time, the ending of the TCP session may be ended through a 3-way handshake between the client 110 and the server 150.

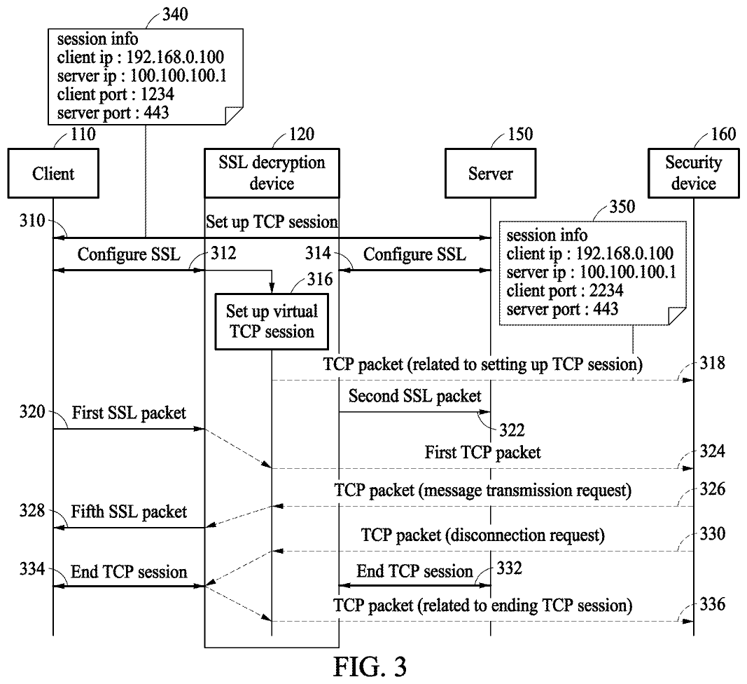

FIG. 3 is a drawing illustrating a process of processing a message transmission request or a disconnection request transmitted from a security device of a security system according to an embodiment of the present invention.

Referring to FIG. 3, a client 110 may set up a TCP session for communication with a server 150 (310). The setting up of the TCP session may be set up through a 3-way handshake between the client 110 and a server 150.

An SSL decryption device 120 may be located between the client 110 and the server 150 to mirror the transmitted and received packet and detect whether the TCP session is set up.

After the TCP session between the client 110 and the server 150 is set up, when a packet (e.g., an SSL Hello packet) about an SSL handshake for establishing an SSL connection between the client 110 and the server 150 is detected, without transmitting the packet about the SSL handshake to the server 150, the SSL decryption device 120 may configure an SSL between the client 110 and the SSL decryption device 120 (312) and may configure an SSL between the SSL decryption device 120 and the server 150 (314). At this time, the configuring of the SSL may be configured through a 3-way handshake between the client 110 and the SSL decryption device 120 or between the SSL decryption device 120 and the server 150.

Then, the SSL decryption device 120 may set up a virtual TCP session between a virtual client corresponding to the client 110 and a virtual server corresponding to the server 150 (316) and may transmit a packet transmitted and received to set up the TCP session between the virtual client and the virtual server to a security device 160 (318).

At this time, the SSL decryption device 120 may match and store five tuples of the virtual client, corresponding to five tuples of the client 110, and may match and store five tuples of the virtual server, corresponding to five tuples of the server 150, to search for a corresponding device subsequently. The five tuples may include at least one of a source IP, a source port, a destination IP, a destination port, a TCP sequence number, and a TCP/UDP protocol.

Meanwhile, when comparing information 340 of the TCP session which is set up between the client 110 and the server 150 with information 350 of the TCP session which is set up between the virtual client and the virtual server, a client 110 IP, a server 150 IP, and a server 150 port have the same value, and a client 110 port has a different value.

Then, when receiving a first SSL packet transmitted from the client 110 to the SSL decryption device 120 (320), the SSL decryption device 120 may decrypt the first SSL packet, may generate a second SSL packet including a payload of the decrypted first SSL packet, and may transmit the second SSL packet to the server 150 (322).

Then, the SSL decryption device 120 may generate and transmit a first TCP packet including a payload of the decrypted first SSL packet transmitted from the virtual client to the virtual server to the security device 160 (324).

When receiving a request to transmit a message to the client 110 from the security device 160, the SSL decryption device 120 may generate and transmit a fifth SSL packet including the message to the client 110 (328). At this time, when receiving a FIN packet including the message transmitted to the client 110 from the security device 160 and receiving an RST packet transmitted to the server 150 from the security device 160, the SSL decryption device 120 may determine that there is the request to transmit the message to the client 110 from the security device 160.

Then, when receiving a request for a disconnection from the security device 160 (328), the SSL decryption device 120 may perform a handshake with the client 110 to end the TCP session between the client 110 and the server 150 (320) and may perform a handshake with the server 150 to end the TCP session between the client 110 and the server 150 (322). At this time, when receiving an RST packet transmitted to each of the client 110 and the server 150 from the security device 160, the SSL decryption device 120 may determine that there is there is the request for the disconnection between the client 110 and the server 150.

After ending the TCP session between the client 110 and the server 150, the SSL decryption device 120 may end the TCP session between the virtual client and the virtual server and may transmit a packet transmitted and received when ending the TCP session between the virtual client and the virtual server to the security device 160 (324).

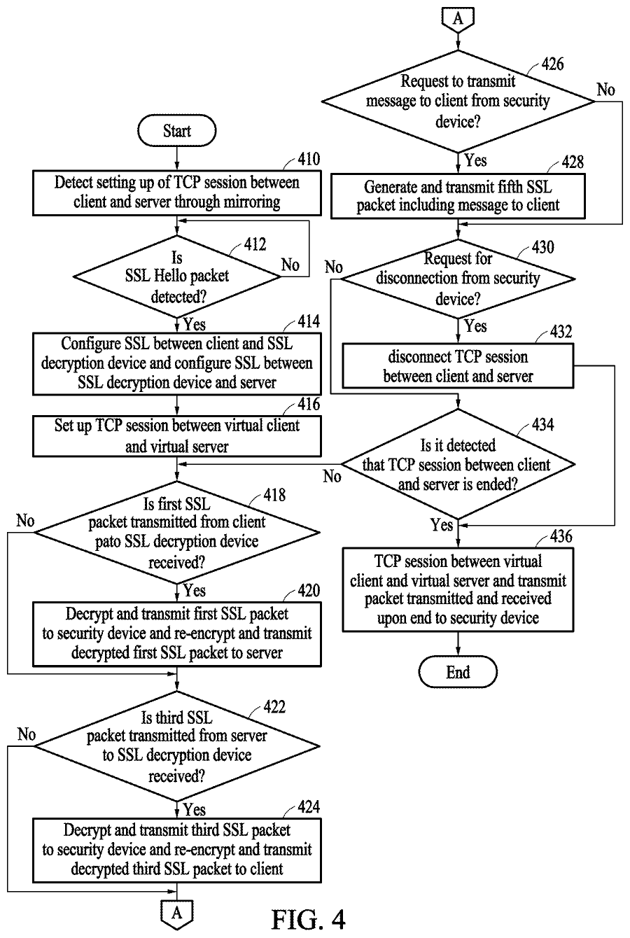

FIG. 4 is a flowchart illustrating a process of decrypting and providing an SSL packet to a security device in an SSL decryption device according to an embodiment of the present invention.

Referring to FIG. 4, a secure sockets layer (SSL) decryption device may detect a 3-way handshake process for setting up a TCP session between a client 110 and a server 150 to detect whether the TCP session between the client 110 and the server 150 is set up (410).

Then, after the TCP session between the client 110 and the server 150 is set up, the SSL decryption device 120 may determine whether a packet (e.g., an SSL Hello packet) about an SSL handshake for establishing an SSL connection between the client 110 and the server 150 is detected (412).

When the packet about the SSL handshake is detected as a result of the determination in step 412, the SSL decryption device 120 may configure an SSL between the client 110 and the SSL decryption device 120 and may configure an SSL between the SSL decryption device 120 and the server 150 (414).

Then, the SSL decryption device 120 may set up a TCP session between a virtual client corresponding to the client 110 and a virtual server corresponding to the server 150 and may transmit a packet transmitted and received to set up the TCP session between the virtual client and the virtual server to a security device 160 (416).

At this time, the SSL decryption device 120 may match and store five tuples of the virtual clients, corresponding to five tuples of the client 110, and may match and store five tuples of the virtual server, corresponding to five tuples of the server 150, to search for a corresponding device subsequently.

Then, the SSL decryption device 120 may determine whether a first SSL packet transmitted from the client 110 to the SSL decryption device 120 is received (418).

When receiving the first SSL packet as a result of the determination in step 418, the SSL decryption device 120 may decrypt and transmit the first SSL packet to the security device 160 and may re-encrypt and transmit the decrypted first SSL packet to the server 150 (420). Thereafter, the SSL decryption device 120 may proceed to step 422.

When the first SSL packet is not received as a result of the determination in step 418, the SSL decryption device 120 may determine whether a third SSL packet transmitted from the server 150 to the SSL decryption device 120 is received (422). When receiving the third SSL packet as a result of the determination in step 422, the SSL decryption device 120 may decrypt and transmit the third SSL packet to the security device 160 and may re-encrypt and transmit the decrypted third SSL packet to the client 110. Thereafter, the SSL decryption device 120 may proceed to step 426.

When the third SSL packet is not received as a result of the determination in step 422, the SSL decryption device 120 may determine whether a request to transmit a message to the client 110 is received from the security device 160 (426).

When the request to transmit the message to the client 110 is received from the security device 160 as a result of the determination in step 426, the SSL decryption device 120 may generate and transmit a fifth SSL packet including the message to the client 110. Thereafter, the SSL decryption device 120 may proceed to step 430.

When the request to transmit the message to the client 110 is not received from the security device 160 as a result of the determination in step 426, the SSL decryption device 120 may determine whether a request for a disconnection is received from the security device 160 (430).

When the request for the disconnection is received from the security device 160 as a result of the determination in step 430, the SSL decryption device 120 may disconnect the TCP session between the client 110 and the server 150 (432). Thereafter, the SSL decryption device 120 may proceed to step 436.

At this time, the SSL decryption device 120 may take the initiative to end the TCP session through a handshake with the client 110 and to end the TCP session through a handshake with the server 150. Because the SSL decryption device 120 is able to intercept a TCP packet transmitted and received between the client 110 and the server 150 in the process, it may operate as if performed in the server 150 when performing the handshake with the client 110 and may operate as if performed in the client 110 when performing the handshake with the server 150, thus ending the TCP session.

When the request for the disconnection is not received from the security device 160 as a result of the determination in step 430, the SSL decryption device 120 may determine that it is detected that the TCP session between the client 110 and the server 150 is ended (434).

When it is not detected that the TCP session between the client 110 and the server 150 is ended, the SSL decryption device 120 may return to step 418 to repeat the process from step 418.

When it is detected that the TCP session between the client 110 and the server 150 is ended as a result of the determination in step 434, the SSL decryption device 120 may end the TCP session between the virtual client and the virtual server and may transmit a packet transmitted and received upon the end to the security device 160 (436).

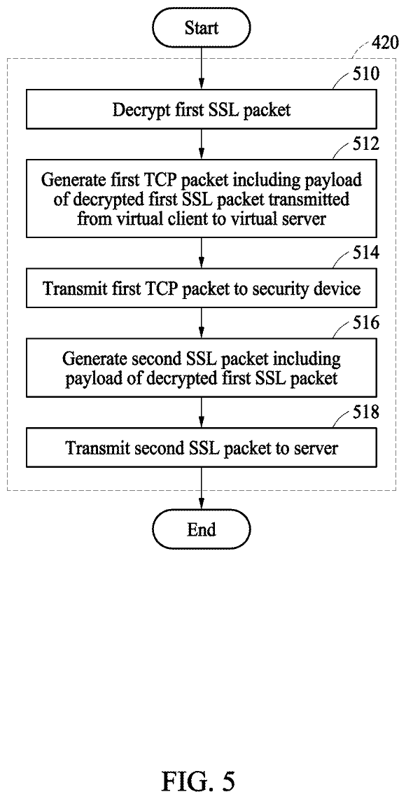

FIG. 5 is a flowchart illustrating in detail a process of processing an SSL packet transmitted by a client in an SSL decryption device according to an embodiment of the present invention.

Referring to FIG. 5, a process of FIG. 5 illustrates in detail step 420 of FIG. 4. An SSL decryption device 120 may decrypt a first SSL packet (510).

Then, the SSL decryption device 120 may generate a first TCP packet including a payload of the decrypted first SSL packet transmitted from a virtual client to a virtual server (512).

Then, the SSL decryption device 120 may transmit the first TCP to a security device 160 (514).

Then, the SSL decryption device 120 may generate a second SSL packet including a payload of the decrypted first SSL packet (516).

Then, the SSL decryption device 120 may transmit the second SSL packet to a server 150 (518).

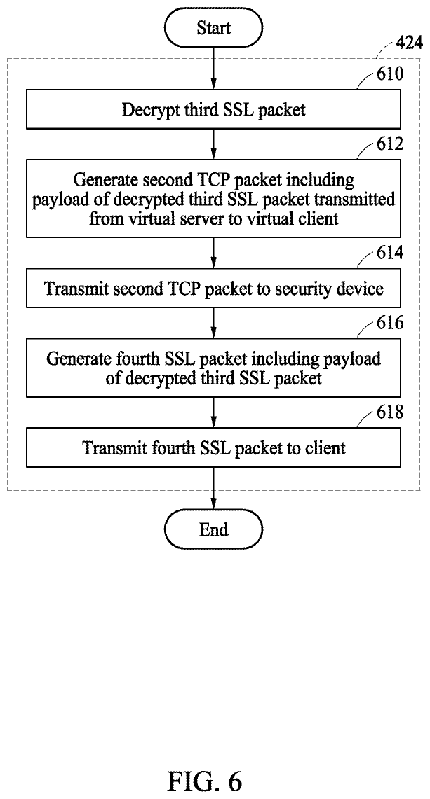

FIG. 6 is a flowchart illustrating in detail a process of processing an SSL packet transmitted by a server in an SSL decryption device according to an embodiment of the present invention.

Referring to FIG. 6, a process of FIG. 6 illustrates in detail step 424 of FIG. 6. An SSL decryption device 120 may decrypt a third SSL packet (610).

Then, the SSL decryption device 120 may generate a second TCP packet including a payload of the decrypted third SSL packet transmitted from a virtual server to a virtual client (612).

Then, the SSL decryption device 120 may transmit the second TCP to a security device 160 (614).

Then, the SSL decryption device 120 may generate a fourth SSL packet including a payload of the decrypted third SSL packet (616).

Then, the SSL decryption device 120 may transmit the fourth SSL packet to a client 110 (618).

The foregoing devices may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described exemplary embodiments of the inventive concept, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. A secure sockets layer (SSL) decryption method in an SSL decryption device, the method comprising:
after a transmission control protocol (TCP) session between a client and a server is set up, detecting a packet about an SSL handshake for establishing an SSL connection between the client and the server;
configuring an SSL between the client and the SSL decryption device and configuring an SSL between the SSL decryption device and the server;
setting up a TCP session between a virtual client corresponding to the client and a virtual server corresponding to the server and transmitting a packet transmitted and received between the virtual client and the virtual server when setting up the TCP session to a security device; and
when receiving a first SSL packet transmitted from the client to the SSL decryption device, decrypting and transmitting the first SSL packet to the security device and re-encrypting and transmitting the decrypted first SSL packet to the server.

2. The method of claim 1, wherein the decrypting and transmitting of the first SSL packet to the security device and the re-encrypting and transmitting of the decrypted first SSL packet to the server includes:
when receiving the first SSL packet transmitted from the client to the SSL decryption device, decrypting the first SSL packet;
generating a first TCP packet including a payload of the decrypted first SSL packet transmitted from the virtual client to the virtual server;
transmitting the first TCP packet to the security device;
generating a second SSL packet including a payload of the decrypted first SSL packet; and
transmitting the second SSL packet to the server.

3. The method of claim 1, further comprising:
when receiving a third SSL packet transmitted from the server to the SSL decryption device, decrypting and transmitting the third SSL packet to the security device and re-encrypting and transmitting the decrypted third SSL packet to the client.

4. The method of claim 3, wherein the decrypting and transmitting of the third SSL packet to the security device and the re-encrypting and transmitting of the decrypted third SSL packet to the client includes:
when receiving the third SSL packet transmitted from the server to the SSL decryption device, decrypting the third SSL packet;
generating a second TCP packet including a payload of the decrypted third SSL packet transmitted from the virtual server to the virtual client;
transmitting the second TCP packet to the security device;
generating a fourth SSL packet including a payload of the decrypted third SSL packet; and
transmitting the fourth packet to the client.

5. The method of claim 1, further comprising:
when it is detected that the TCP session between the client and the server is ended, ending the TCP session between the virtual client and the virtual server and transmitting a packet transmitted and received between the virtual client and the virtual server when ending the TCP session to the security device.

6. The method of claim 1, further comprising:
when receiving a request to transmit a message to the client from the security device, generating and transmitting a fifth SSL packet including the message to the client.

7. The method of claim 6, wherein the request to transmit the message to the client from the security device is determined as a request to transmit the message to the client from the security device when receiving a FIN packet including the message transmitted to the client from the security device and when receiving an RST packet transmitted to the server from the security device.

8. The method of claim 1, further comprising:
when receiving a request to disconnect the connection between the client and the server from the security device, disconnecting the connection between the client and the server; and
ending the TCP session between the virtual client and the virtual server and transmitting a packet transmitted and received between the virtual client and the virtual server when ending the TCP session to the security device.

9. The method of claim 8, wherein the request to disconnect the connection between the client and the server from the security device is determined as a request to disconnect the connection between the client and the server when receiving an RST packet transmitted to each of the client and the server from the security device.

10. The method of claim 1, wherein the setting up of the TCP session between the virtual client corresponding to the client and the virtual server corresponding to the server and the transmitting of the packet transmitted and received between the virtual client and the virtual server when setting up the TCP session to the security device includes:
matching and storing five tuples of the virtual client, corresponding to five tuples of the client, and matching and storing five tuples of the virtual server, corresponding to five tuples of the server.

11. The method of claim 1, wherein client IPs, server IPs, and server ports have the same value as each other and client ports have different values from each other, when comparing information of the TCP session which is set up between the client and the server with information of the TCP session which is set up between the virtual client and the virtual server.

12. A computer-readable storage medium storing instructions that, when executed by a processor, cause the processor to perform a secure sockets layer (SSL) decryption method in an SSL decryption device, the method comprising:
after a transmission control protocol (TCP) session between a client and a server is set up, detecting a packet about an SSL handshake for establishing an SSL connection between the client and the server;
configuring an SSL between the client and the SSL decryption device and configuring an SSL between the SSL decryption device and the server;
setting up a TCP session between a virtual client corresponding to the client and a virtual server corresponding to the server and transmitting a packet transmitted and received between the virtual client and the virtual server when setting up the TCP session to a security device; and
when receiving a first SSL packet transmitted from the client to the SSL decryption device, decrypting and transmitting the first SSL packet to the security device and re-encrypting and transmitting the decrypted first SSL packet to the server.

13. The computer-readable storage medium of claim 12, wherein the decrypting and transmitting of the first SSL packet to the security device and the re-encrypting and transmitting of the decrypted first SSL packet to the server includes:
when receiving the first SSL packet transmitted from the client to the SSL decryption device, decrypting the first SSL packet;
generating a first TCP packet including a payload of the decrypted first SSL packet transmitted from the virtual client to the virtual server;
transmitting the first TCP packet to the security device;
generating a second SSL packet including a payload of the decrypted first SSL packet; and
transmitting the second SSL packet to the server.

14. The computer-readable storage medium of claim 12, further comprising:
when receiving a third SSL packet transmitted from the server to the SSL decryption device, decrypting and transmitting the third SSL packet to the security device and re-encrypting and transmitting the decrypted third SSL packet to the client.

15. The computer-readable storage medium of claim 14, wherein the decrypting and transmitting of the third SSL packet to the security device and the re-encrypting and transmitting of the decrypted third SSL packet to the client includes:
when receiving the third SSL packet transmitted from the server to the SSL decryption device, decrypting the third SSL packet;
generating a second TCP packet including a payload of the decrypted third SSL packet transmitted from the virtual server to the virtual client;
transmitting the second TCP packet to the security device;
generating a fourth SSL packet including a payload of the decrypted third SSL packet; and
transmitting the fourth packet to the client.

16. The computer-readable storage medium of claim 12, further comprising:
when it is detected that the TCP session between the client and the server is ended, ending the TCP session between the virtual client and the virtual server and transmitting a packet transmitted and received between the virtual client and the virtual server when ending the TCP session to the security device.

17. The computer-readable storage medium of claim 12, further comprising:
when receiving a request to transmit a message to the client from the security device, generating and transmitting a fifth SSL packet including the message to the client.

18. The computer-readable storage medium of claim 17, wherein the request to transmit the message to the client from the security device is determined as a request to transmit the message to the client from the security device when receiving a FIN packet including the message transmitted to the client from the security device and when receiving an RST packet transmitted to the server from the security device.

19. The computer-readable storage medium of claim 12, further comprising:
when receiving a request to disconnect the connection between the client and the server from the security device, disconnecting the connection between the client and the server; and
ending the TCP session between the virtual client and the virtual server and transmitting a packet transmitted and received between the virtual client and the virtual server when ending the TCP session to the security device.

20. The computer-readable storage medium of claim 19, wherein the request to disconnect the connection between the client and the server from the security device is determined as a request to disconnect the connection between the client and the server when receiving an RST packet transmitted to each of the client and the server from the security device.
